(19) United States
(12) Patent Application Publication
(10) Pub. No.: US 2026/0221040 A1
(43) Pub. Date: Jul. 30, 2026

(54) INTENT MESSAGE SHARING WITH OCCUPANT PREFERENCES

(71) Applicant: Toyota Motor Engineering & Manufacturing North America, Inc., Plano, TX (US)

(72) Inventors: Rohit Gupta, Santa Clara, CA (US); Ahmadreza Moradipari, Mountain View, CA (US); Sergei S. Avedisov, Redwood City, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/036,478

(22) Filed: Jan. 24, 2025

(51) Int. Cl. G08G 1/00; B60W 50/00

(52) U.S. Cl. CPC G08G 1/22; B60W 50/0098; B60W 2050/0083; B60W 2556/65

(57) ABSTRACT

Systems and methods described herein relate to generating a preference set for a vehicle occupant, optimizing a coordinated vehicular action based on the preference set, and generating an intent-sharing message based on the coordinated vehicular action. For example, preference sets for vehicle occupants may allow them to optimize coordinated vehicular actions with respect to their preferences regarding energy efficiency and social associations.

### TECHNICAL FIELD

The subject matter described herein relates, in general, to strategies for evaluating occupant preferences in the context of intent message sharing between vehicles.

### BACKGROUND

Connected and automated vehicles (CAVs) may address safety and sustainability challenges in transportation systems, such as with Cooperative Adaptive Cruise Control (CACC) that provides enhanced car-following capabilities through vehicle-to-vehicle communications.

### SUMMARY

In one embodiment, a vehicle management system is disclosed. The vehicle management system includes one or more processors and a memory communicably coupled to the one or more processors. The memory stores a command module including instructions that when executed by the one or more processors cause the one or more processors to generate a preference set for a vehicle occupant, optimize a coordinated vehicular action based on the preference set, and generate an intent-sharing message based on the coordinated vehicular action.

In one embodiment, a non-transitory computer-readable medium including instructions that when executed by one or more processors cause the one or more processors to generate a preference set for a vehicle occupant, optimize a coordinated vehicular action based on the preference set, and generate an intent-sharing message based on the coordinated vehicular action.

In one embodiment, a method is disclosed. In one embodiment, the method includes generating a preference set for a vehicle occupant, optimizing a coordinated vehicular action based on the preference set, and generating an intent-sharing message based on the coordinated vehicular action.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an accuracy estimation system that is associated with evaluating occupant preferences in the context of intent message sharing between vehicles.

FIG. 3 illustrates one embodiment of a cloud computing environment within which the systems and methods described herein may operate.

FIG. 4 illustrates one example of preference set entries regarding mood preferences.

FIG. 5 illustrates one example of preference set entries regarding impairment preferences.

FIG. 6 illustrates one example of preference set entries regarding efficiency preferences.

FIG. 7 illustrates one example of preference set entries regarding association preferences.

FIG. 8 illustrates one example of operational constraints relating to mood preferences.

FIG. 9 illustrates one example of operational constraints relating to impairment preferences.

FIG. 10 illustrates one example of operational constraints relating to efficiency preferences.

FIG. 11 illustrates one example of operational constraints relating to association preferences.

FIG. 12 illustrates one example of a method for evaluating occupant preferences in the context of intent message sharing between vehicles.

### DETAILED DESCRIPTION

Systems, methods, and other embodiments are described herein associated with evaluating occupant preferences in the context of intent message sharing between vehicles. When vehicles seek to coordinate activity between them, intent-sharing messages may allow such vehicles to better predict the actions of other vehicles. However, traditional intent-sharing messages describe only the intended vehicular actions to be executed.

Accordingly, preference sets for vehicle occupants are described that allow for intent-sharing messages to communicate occupant preferences affecting intended vehicular actions. Further, such preference sets allow for optimizing coordinated vehicular actions (e.g., platoons) to better match the desires of vehicle occupants (e.g., preferring vehicle platoons only having electric vehicles).

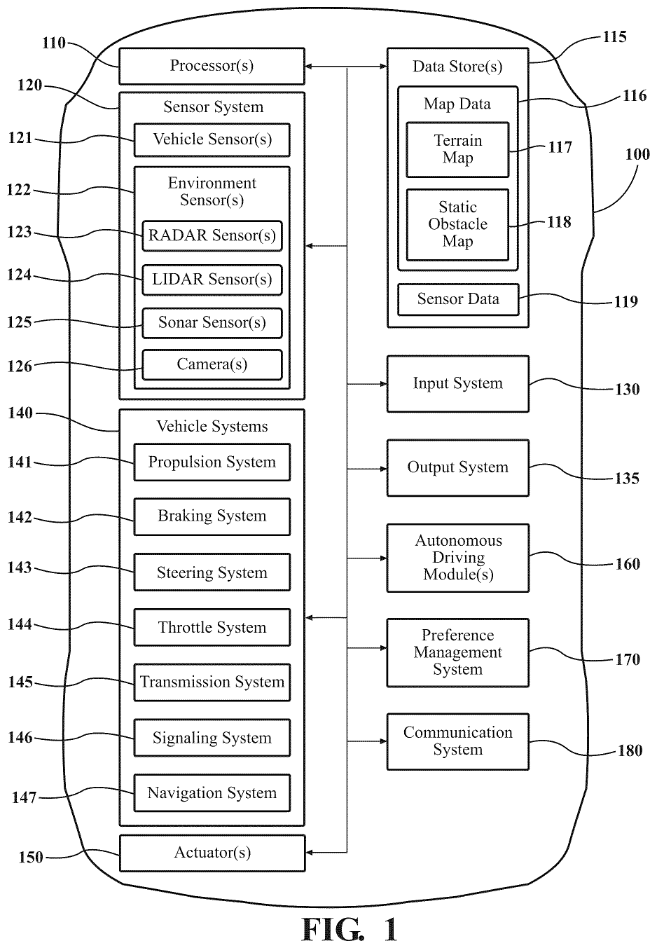

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

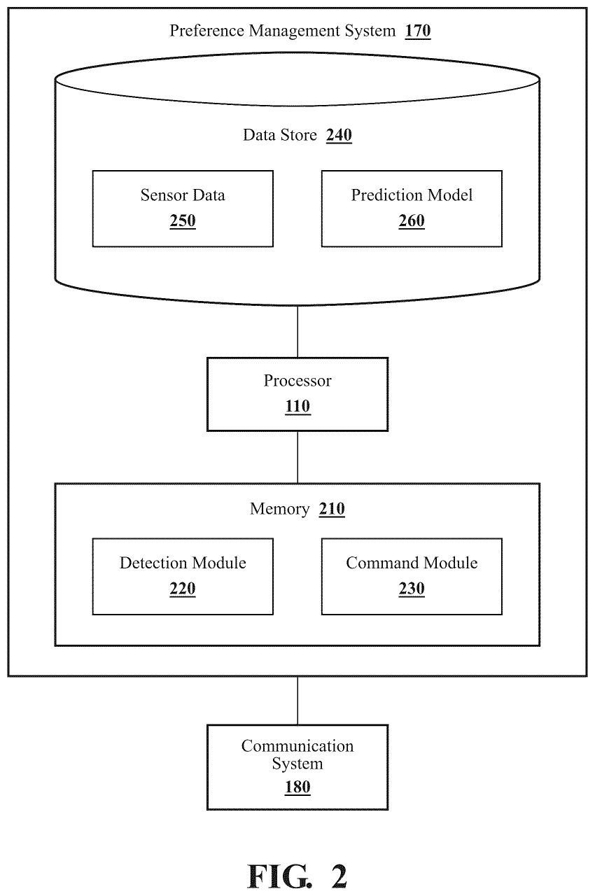

Some of the possible elements of vehicle 100 are shown in FIG. 1 and will be described along with subsequent figures. However, a description of many of the elements in FIG. 1 will be provided after the discussion of FIGS. 2-12 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a preference management system 170 that is implemented to perform methods and other functions as disclosed herein. As will be discussed in greater detail subsequently, preference management system 170, in various embodiments, is implemented partially within vehicle 100 and as a cloud-based service. For example, in one approach, functionality associated with at least one module of preference management system 170 is implemented within vehicle 100 while further functionality is implemented within a cloud-based computing system.

With reference to FIG. 2, one embodiment of preference management system 170 of FIG. 1 is further illustrated. Preference management system 170 is shown as including processors 110 from vehicle 100 of FIG. 1. Accordingly, processors 110 may be a part of preference management system 170, preference management system 170 may include a separate processor from processors 110 of vehicle 100, or preference management system 170 may access processors 110 through a data bus or another communication path. In one embodiment, preference management system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processors 110 cause processors 110 to perform the various functions disclosed herein.

Preference management system 170 as illustrated in FIG. 2 is generally an abstracted form of preference management system 170 as may be implemented between vehicle 100 and a cloud-computing environment. Accordingly, preference management system 170 may be embodied at least in part within a cloud-computing environment to perform the methods described herein.

With reference to FIG. 2, detection module 220 generally includes instructions that function to control processors 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on.

In one embodiment, detection module 220 may also acquire sensor data 250 from one or more sensors that allows for the detection of load characteristics for a load that will be transported by a vehicle or trailer. For example, load data may be comprised of any sensor data 250 that may be relevant to the determination of the size (e.g., height, width, length), weight, density, or any other static or dynamic property of a load that may affect vehicle operation before, during, or after transport. A load may be any form of cargo or freight that is transported on a trailer, on a vehicle (e.g., in a pickup truck bed), or as a detachable part of a trailer or vehicle.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link from one or more of the surrounding vehicles or other sources (e.g., via V2V, V2I, V2X), or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, preference management system 170 includes a database 240. Database 240 is, in one embodiment, an electronic data structure stored in memory 210 or another data store and that is configured with routines that may be executed by processors 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processors 110 to obtain load characteristics as described herein. In some embodiments, detection module 220 may receive and store load characteristics.

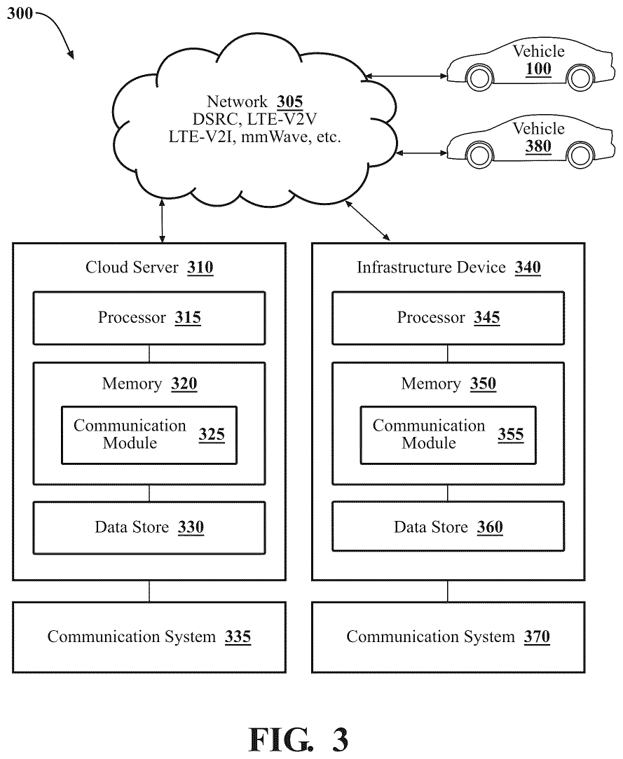

In one embodiment, command module 230 generally includes instructions that function to control the processors 110 or collection of processors in the cloud-computing environment 300 as shown in FIG. 3.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of preference management system 170 through network 305 via communication system 335 (e.g., a network router or bridge). In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of preference management system 170 through network 305 via communication system 370 (e.g., a network router or bridge). In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, preference management system 170 may obtain information from cloud servers (e.g., cloud server 310), infrastructure devices (e.g., infrastructure device 340), other vehicles (e.g., vehicle 380), and any other systems connected to network 305. For example, cloud servers (e.g., cloud server 310) may be used to perform the same tasks as described herein with respect to command module 230.

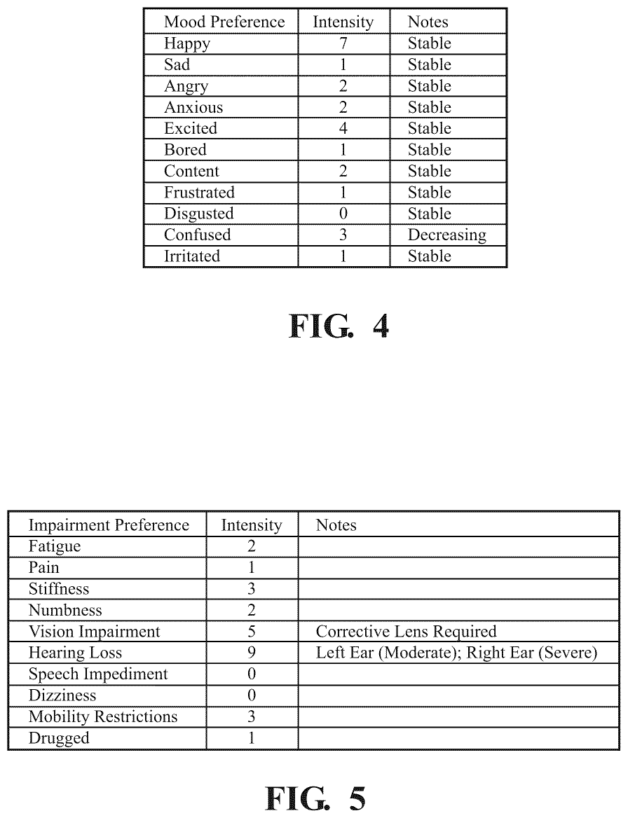

In some embodiments, command module 230 may record a preference set associated with a vehicle occupant, which may contain one or more measures of the mood of the vehicle occupant. For example, as shown in FIG. 4, command module 230 may generate entries for mood preferences (e.g. “Happiness”) and intensity values associated with those mood preferences (e.g., 7, 4). In some embodiments, a user may record a mood preference and intensity value (e.g., by selecting icons on a vehicle display of vehicle 100 or through a smart device).

In some embodiments, command module 230 may take various inputs regarding the behavior of the vehicle occupant (e.g., vehicular control inputs, audio and visual data of the occupant) and use them as inputs to a neural network or other vehicular function that has been trained or designed to provide an estimate of an intensity value for a mood preference. Command module 230 may then record in a preference set for the vehicle occupant the output of such a neural network or other vehicular function as an intensity value associated with a mood preference.

In some embodiments, a preference set associated with a vehicle occupant may also contain information regarding the physical state of the vehicle occupant. For example, as shown in FIG. 5, command module 230 may generate entries for impairment preferences (e.g. “Hearing Impairment”) and intensity values associated with those impairment preferences (e.g., 9, 5).

In some embodiments, command module 230 may take various inputs regarding the behavior of the vehicle occupant (e.g., vehicular control inputs, audio and visual data of the occupant) and use them as inputs to a neural network or other vehicular function that has been trained or designed to provide an estimate of an intensity value for an impairment preference. Command module 230 may then record in a preference set for the vehicle occupant the output of such a neural network or other vehicular function as an intensity value associated with the impairment preference. In some embodiments, command module 230 may also record further information in association with an impairment preference, such as notes about the areas affected by the impairment, a corrective apparatus that alleviates the impairment, etc.

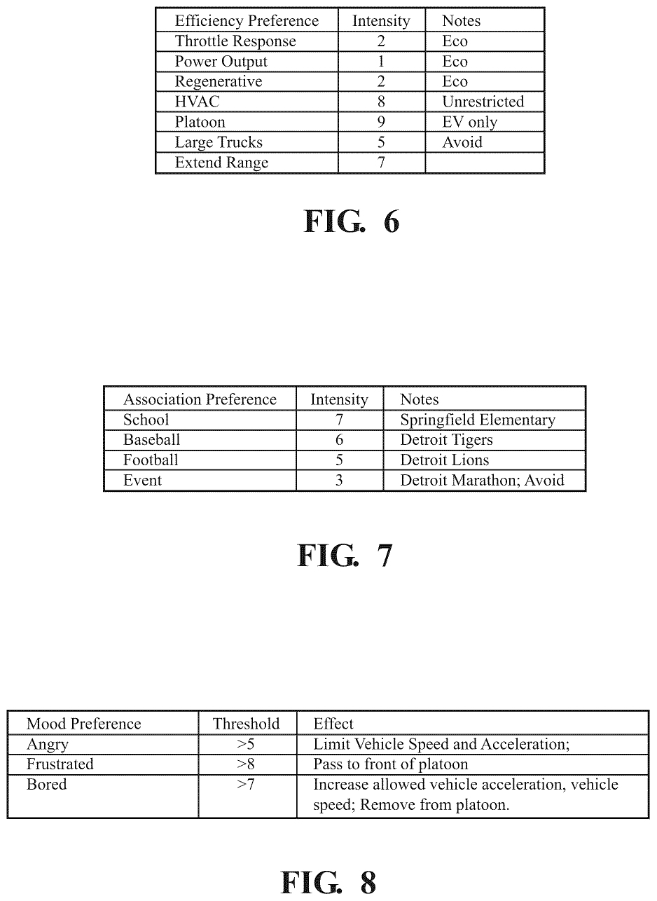

In some embodiments, a preference set associated with a vehicle occupant may also contain information regarding the efficiency preferences for the vehicle occupant that affect vehicular actions in terms of energy efficiency. For example, as shown in FIG. 6, command module 230 may generate entries for efficiency preferences (e.g., “throttle response”) and an intensity value associated with the efficiency setting (e.g., “2”). In some embodiments, efficiency preferences and their associated intensity values may indicate the extent that energy efficiency is desired (or not) in terms of the performance of vehicle functions, such as throttle response and regenerative breaking. In some embodiments, command module 230 may also record further information in association with an efficiency preference, such as notes about specific characteristics that are desirable or undesirable in relation to an efficiency preference (e.g., vehicle preferences, minimum speeds).

In some embodiments, efficiency preferences and their associated intensity values in a preference set for a vehicle occupant may also modify the actions of the vehicle within a platoon or other coordinated vehicular actions. For example, energy efficiency within the context of coordinated vehicular actions can be affected by vehicle type and mass, inter-vehicle spacing, speed, communication and control, driver/vehicle behavior, etc. In various contexts, determinations or actions that are optimal in terms of energy efficiency between coordinated and connected vehicles, such as those operating in a platoon, may be too discomforting to a vehicle occupant to accept. As such, efficiency preferences may allow vehicle occupants to place constraints on what is acceptable actions or outcomes in relation to command module 230 optimizing for energy efficiency in coordinated vehicular actions.

For example, a vehicle occupant that regularly drives a small convertible sports car may be uncomfortable being in close proximity to large or heavy vehicles. Accordingly, an efficiency setting in a preference set associated with the vehicle occupant may specify the size of a following vehicle (or leading vehicle) the vehicle occupant can or cannot tolerate being next to when in a platoon (e.g., avoid tractor trailers). As another example, a vehicle occupant may be uncomfortable with inter-vehicle spacing or speeds that the vehicle occupant considers to be “too close” or “too fast”. As such, an efficiency setting for the vehicle occupant may specify desired limits on inter-vehicle spacing, average platoon speed, etc. As yet another example, a vehicle occupant may be uncomfortable with the higher or lower level of coordinated behavior between vehicles having different communication and control capabilities, such that a preference set may have an efficiency setting preferring or seeking to exclude certain classes of vehicles (e.g., exclude vehicles that are only level 1 compliant with a vehicular standard, but include those that are level 2 compliant with the vehicular standard; exclude vehicles that do not have LIDAR) from a coordinated vehicular action (e.g., platooning). As yet a further example, driver/vehicle behaviors may reflect certain preferences (e.g., minimize time to destination, cruise in comfort, avoid lane changes) that are or are not desirable to a vehicle occupant. As such, a vehicle occupant may use efficiency preferences to maximize or minimize participation in such driver/vehicle behaviors even if such participation constrains command module 230 in optimizing for energy efficiency.

In some embodiments, a preference set associated with a vehicle occupant may also contain information regarding desired social associations of the vehicle occupant. For example, as shown in FIG. 7, command module 230 may generate entries for association preferences such as school, workplace, team, event, etc. to indicate how the vehicle occupant would enjoy coordinated vehicular actions (e.g., platooning) with other vehicles having vehicle occupants sharing the same association preference. For example, a parent dropping off a child at school may desire opportunities for coordinated vehicle actions (e.g., platooning) with vehicles of other parents whose children attend the same school. Similarly, commuters heading to the same area may desire opportunities for coordinated vehicle actions (e.g., platooning) with vehicles of other commuters that work in the same area. As another example, a sports fan going to a game may desire opportunities for coordinated vehicle actions (e.g., platooning) with vehicles of other fans who are attending the game.

In some embodiments, an association preference may also be used to indicate a preference to avoid coordinated vehicle actions (e.g., platooning) with vehicles of other vehicle occupants that are being coordinated through a certain association preference. For instance, a sports fan leaving a game would likely prefer to not be in a platoon with fans of the rival team and as such may indicate by an association preference related to the rival team an avoidance preference. As another example, a vehicle occupant may wish to avoid traffic associated with an event (e.g., people heading to or from a game, concert, parade, etc.) by similarly recording an avoidance preference in an association preference relating to the event.

In some embodiments, command module 230 may be instructed to share an association preference, such as through communication to another vehicle or through a third-party service (e.g., social media). For example, a vehicle occupant may wish to coordinate a funeral procession, impromptu celebratory parade, or other coordinated vehicular actions that other vehicle occupants may wish to participate in. Accordingly, upon receiving information about an association preference, command module 230 may add such an association preference to a preference set for an occupant. In some embodiments, command module 230 may only add such an association preference to a preference set for a vehicle occupant upon explicit approval by the originator of the association preference, by the vehicle occupant, or both.

In some embodiments, command module 230 may use a predictive controller for participating in coordinated vehicle actions (e.g., platooning). For example, command module 230 may utilize a model-predictive controller that uses a representation of a system to predict the system's behavior over a given horizon, an objective function that represents what system behavior is desirable, a mathematical formalization of operational constraints that have to be satisfied, measurements of the state of the system, and information regarding any disturbances that may be encountered. Such a model-predictive controller (or any other predictive controller) may be provided by automated driving module(s) 160 for use by command module 230.

In some embodiments, command module 230 may determine whether an operational constraint should be in effect for a predictive controller based on one or more preference sets associated with vehicle occupants. In some embodiments, an operational constraint may specify a limit to a vehicle action or behavior based on whether an intensity value or other information within one or more preference sets satisfies one or more thresholds. In some embodiments, operational constraints relating to a preference set for a vehicle occupant may be stored within the preference set by command module 230.

For example, as shown with respect to FIG. 8, command module 230 may apply one or more thresholds to one or more mood preferences and their associated intensity values to determine if one or more operational constraints relating to such mood preferences should be applied. For example, if command module 230 determines that the intensity value of the mood preference “angry” exceeds a threshold, then command module 230 may apply operational constraints relating to that mood preference (e.g., operational constraints selected to calm the vehicle occupant, such as limiting vehicle speed, limiting vehicle acceleration, placing vehicle 100 in a platoon, etc.).

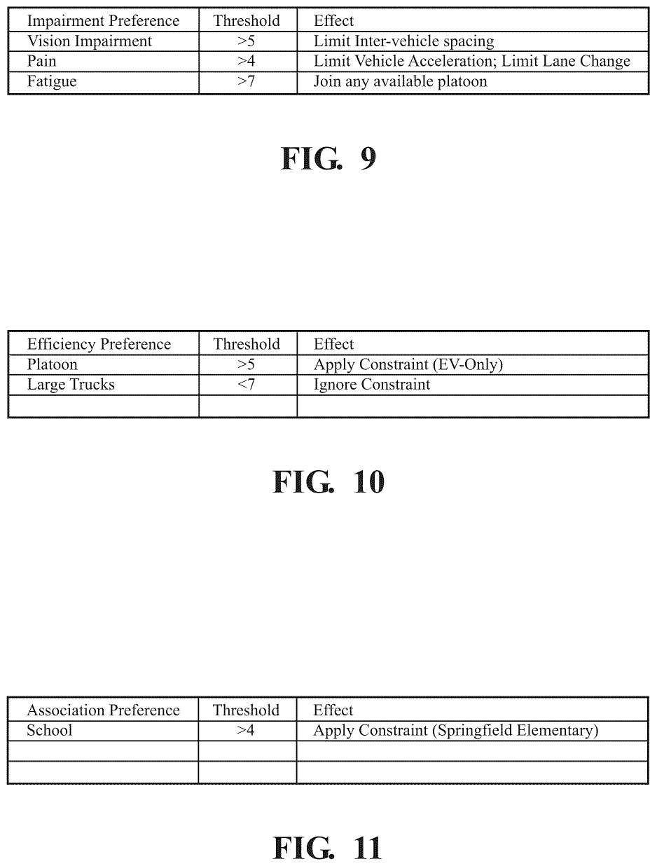

As another example, as shown with respect to FIG. 9, command module 230 may apply one or more thresholds to one or more impairment preferences and their associated intensity values to determine if one or more operational constraints should be applied. For example, if command module 230 determines that the intensity value of the impairment preference “pain” exceeds a threshold, then command module 230 may apply operational constraints relating to that impairment preference (e.g., operational constraints selected to reduce discomfort to the vehicle occupant, such as limiting vehicle acceleration and braking).

As yet another example, as shown with respect to FIG. 10, command module 230 may apply one or more thresholds to one or more efficiency preferences and their associated intensity values to determine if one or more operational constraints should be applied. For example, if command module 230 determines that the intensity value of the efficiency setting “Large Trucks” is below a threshold, then command module 230 may apply operational constraints relating to that efficiency preference (e.g., ignore the preference to avoid trucks).

As yet a further example, as shown with respect to FIG. 11, command module 230 may apply one or more thresholds to one or more association preferences and their associated intensity values to determine if one or more operational constraints should be applied. For example, if command module 230 determines that the intensity value of the association preference “School” exceeds a threshold, then command module 230 may may apply operational constraints relating to that association preference (e.g., operational constraints preferring vehicle platoons with same association preference; operational constraints avoiding an opposing association preference).

While the above examples are given separately with respect to mood preference, impairment preference, efficiency preference, and association preference, it should be understood that an operational constraint may also be defined in terms of a combination thereof. For example, an operational constraint may require that a first intensity value associated with a mood preference satisfy a first threshold and that a second intensity value associated with an impairment preference satisfy a second threshold before it can be applied. Moreover, while the above examples are discussed with respect to whether intensity values satisfy one or more thresholds, the applicability of an operational constraint may also be determined by evaluating additional information associated with a mood preference, impairment preference, efficiency preference, association preference, or a combination thereof. For example, an operational constraint may only be applicable if an efficiency preference “vehicle avoidance” has an intensity value satisfying a threshold (e.g., greater than 7) and there is information associated with that efficiency preference specifying the type of vehicles to be avoided (e.g., non-electric vehicles).

In some embodiments, an intent-sharing message sent by command module 230 for a vehicle may contain a preference set for a vehicle occupant within that vehicle (or a portion thereof). In some embodiments, an intent-sharing message sent by command module 230 for a vehicle may contain operational constraints that have been determined to be applicable for a vehicle occupant of that vehicle, which may also include any information giving rise to that determination. In this manner, where for example a local controller may be operating under a distributed model predictive controller, the preference set, operational constraints, and any additional information that may be included in the intent-sharing message allow for the local controller to be aware of the preference set or operational constraints being applied on behalf of another vehicle occupant in another vehicle. In some embodiments, where command module 230 is aware of an operational constraint being applied relative to vehicle 100 due to a preference set, operational constraint, etc., command module 230 may constrain vehicle actions that would be contrary to such an operational constraint. For example, if a following vehicle of vehicle 100 sends an intent-sharing message to vehicle 100 that it intends to temporarily slow down to increase the inter-vehicle distance between it and vehicle 100, then command module 230 may apply a temporary operational constraint that vehicle 100 should avoid slowing down.

In some embodiments, operational constraints for coordinated vehicle actions (e.g., platooning) may affect vehicle speed, vehicle acceleration, vehicle braking, inter-vehicle spacing, lane changes, lateral positioning, emergency responses, passing within a platoon, platoon joining, platoon leaving, traffic signal coordination, efficiency optimization, etc. For example, if a preference set indicates that a vehicle occupant has a “bored” mood preference with an intensity value above a pre-determined threshold, command module 230 may apply operational constraints for such a situation that are designed to alleviate boredom within a platoon. Examples of that may be increasing vehicle speed, increasing vehicle acceleration, increased braking, reducing inter-vehicle spacing, increasing the allowance for lane changes, passing the vehicle to the front of the platoon, etc.

As another example, if a preference set indicates that a vehicle occupant has a “extend range” efficiency preference with an intensity value above a pre-determined threshold, command module 230 may apply operational constraints for such a situation that are designed to extend range within a platoon. Examples of that may be limiting vehicle speed, limiting vehicle acceleration, etc.

In some embodiments, command module 230 may determine based on any two or more preference sets a compatibility score between such preference sets. For example, command module 230 may evaluate a pair of preference sets to determine the extent of potential conflicts between them if vehicles subject to such preference sets engaged in a coordinated vehicular activity.

In some embodiments, command module 230 may adjust thresholds relating to operational constraints, such as where command module 230 determines that increasing one or more thresholds will increase the number of vehicles available to participate in a coordinated vehicular activity (e.g., platooning).

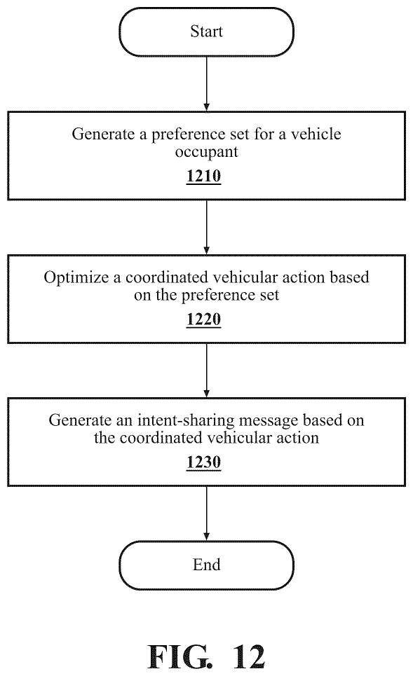

FIG. 12 illustrates a flowchart of a method 1200 that is associated with strategies for evaluating the accuracy of trajectory prediction in intent messages between connected vehicles. Method 1200 will be discussed from the perspective of the preference management system 170 of FIGS. 1 and 2. While method 1200 is discussed in combination with the preference management system 170, it should be appreciated that the method 1200 is not limited to being implemented within preference management system 170 but is instead one example of a system that may implement method 1200.

At step 1210, command module 230 may generate a preference set for a vehicle occupant. For example, command module 230 may receive information regarding the preferences of a vehicle occupant (e.g., via a neural network observing the vehicle occupant; via user input) and record such information as a mood preference, impairment preference, efficiency preference, association preference, etc. In addition, command module 230 may use such information to assign one or more intensity values to one or more mood preferences, impairment preferences, efficiency preferences, association preferences, etc. or to append additional information to one or more mood preferences, impairment preferences, efficiency preferences, association preferences, etc. In some embodiments, a preference set may represent a group of vehicle occupants (e.g., all vehicle occupants within a vehicle) rather than solely an individual vehicle occupant, such as where command module 230 merges two or more preference sets to create a “group” preference set.

At step 1220, command module 230 may optimize a coordinated vehicular action based on the preference set. In some embodiments, command module 230 may use a predictive controller that seeks to optimize safety, comfort, and one or more preference sets to achieve an objective goal. In some embodiments, command module 230 may determine if one or more operational constraints should affect such optimization be evaluating one or more preference sets.

At step 1230, command module 230 may generate an intent-sharing message based on the coordinated vehicular action. In some embodiments, the intent-sharing message can include preference sets or any information relating to an operational constraint based on a preference set being in effect.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, preference management system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, preference management system 170, automated driving module(s) 160, or any combination thereof may control some or all of these vehicle system(s) 140 and, thus, may be partially or fully autonomous.

Processor(s) 110, preference management system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, preference management system 170, automated driving module(s) 160, or any combination thereof may control the direction, speed, or both of vehicle 100. Processor(s) 110, preference management system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving module(s) 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with preference management system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-12, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
generate a preference set for a vehicle occupant;
optimize a coordinated vehicular action based on the preference set; and
generate an intent-sharing message based on the coordinated vehicular action.

2. The system of claim 1, wherein the machine-readable instructions to generate the preference set includes at least one efficiency preference capable of affecting the coordinated vehicular action.

3. The system of claim 1, wherein the machine-readable instructions to generate the preference set includes at least one association preference capable of affecting the coordinated vehicular action.

4. The system of claim 1, wherein the machine-readable instructions to generate the intent-sharing message includes storing at least a portion of the preference set in the intent-sharing message.

5. The system of claim 1, wherein the machine-readable instructions to generate the intent-sharing message includes storing information describing an operational constraint in effect due to the preference set in the intent-sharing message.

6. The system of claim 1, wherein the machine-readable instructions to optimize the coordinated vehicular action based on the preference set involves a vehicle operating within a platoon.

7. The system of claim 1, wherein the machine-readable instructions to optimize the coordinated vehicular action based on the preference set prevents participation of another vehicle based on the preference set.

8. A non-transitory computer-readable medium including instructions that when executed by one or more processors cause the one or more processors to:
generate a preference set for a vehicle occupant;
optimize a coordinated vehicular action based on the preference set; and
generate an intent-sharing message based on the coordinated vehicular action.

9. The non-transitory computer-readable medium of claim 8, wherein the instruction to generate the preference set includes at least one efficiency preference capable of affecting the coordinated vehicular action.

10. The non-transitory computer-readable medium of claim 8, wherein the instruction to generate the preference set includes at least one association preference capable of affecting the coordinated vehicular action.

11. The non-transitory computer-readable medium of claim 8, wherein the instruction to generate the intent-sharing message includes storing at least a portion of the preference set in the intent-sharing message.

12. The non-transitory computer-readable medium of claim 8, wherein the instruction to generate the intent-sharing message includes storing information describing an operational constraint in effect due to the preference set in the intent-sharing message.

13. The non-transitory computer-readable medium of claim 8, wherein the instruction to optimize the coordinated vehicular action based on the preference set involves a vehicle operating within a platoon.

14. A method, comprising:
generating a preference set for a vehicle occupant;
optimizing a coordinated vehicular action based on the preference set; and
generating an intent-sharing message based on the coordinated vehicular action.

15. The method of claim 14, wherein generating the preference set includes at least one efficiency preference capable of affecting the coordinated vehicular action.

16. The method of claim 14, wherein generating the preference set includes at least one association preference capable of affecting the coordinated vehicular action.

17. The method of claim 14, wherein generating the intent-sharing message includes storing at least a portion of the preference set in the intent-sharing message.

18. The method of claim 14, wherein generating the intent-sharing message includes storing information describing an operational constraint in effect due to the preference set in the intent-sharing message.

19. The method of claim 14, wherein optimizing the coordinated vehicular action based on the preference set involves a vehicle operating within a platoon.

20. The method of claim 14, wherein optimizing the coordinated vehicular action based on the preference set prevents participation of another vehicle based on the preference set.
